(19) United States
(12) Patent Application Publication
(10) Pub. No.: US 2014/0175076 A1
(43) Pub. Date: Jun. 26, 2014

(54) WELDING HEAD

(71) Applicant: CATERPILLAR INC., Peoria, IL (US)

(72) Inventors: Huijun Wang, Peoria, IL (US); Matthew J. Behmlander, Metamora, IL (US); Timothy A. Thorson, Morton, IL (US); Fred E. Sallo, Galesburg, IL (US)

(73) Assignee: Caterpillar Inc., Peoria, IL (US)

(21) Appl. No.: 13/723,310

(22) Filed: Dec. 21, 2012

(51) Int. Cl. B23K 9/28

(52) U.S. Cl. CPC B23K 9/28
USPC 219/138

(57) ABSTRACT

A welding head is provided. The welding head includes a bracket. The bracket includes a central block coupled to it. The central block includes a tip holder detachably coupled to a lower portion of the central block and a plurality of contact tips attached to the tip holder. Each contact tip is adapted to receive an electrode. The bracket also includes a pair of side blocks pivotally coupled to the bracket and provided on either sides of the central block. Each side block includes a side tip holder detachably coupled to a lower portion of the side block and a side contact tip attached to the side tip holder. Each of the side contact tip is adapted to receive the electrode. The side blocks are capable of variable positioning relative to the bracket.

### TECHNICAL FIELD

The present disclosure relates to a welding head, and more particularly a welding head for multiple electrode cladding.

### BACKGROUND

Welding heads with multiple electrodes configuration can be used to deposit a cladding layer on a substrate. U.S. Published Application No. 2010/0326963 relates to a welding device including an electrode head adapted to concurrently house an array of associated multiple, continuous-feed electrodes in a spaced apart configuration for concurrently depositing cladding material on the surface of a workpiece.

However, the currently known designs of the multiple electrode setup may present a variety of operational and maintenance issues. For example, these issues may include, difficulty in contact tip changing, overheating of the welding head during a relatively long run cladding process, difficulty in arc flame control in order to prevent spreading of flames from one electrode to another, difficulty in fine adjusting the width of the clad layer, and the like.

Hence, there is a need of an improved design for the multiple electrode cladding welding head in order to overcome the above mentioned and additional shortcomings.

### SUMMARY OF THE DISCLOSURE

In one aspect of the present disclosure, a welding head is provided. The welding head includes a bracket. The bracket includes a central block coupled to it. The central block includes a tip holder detachably coupled to a lower portion of the central block and a plurality of contact tips attached to the tip holder. Each contact tip is adapted to receive an electrode. The bracket also includes a pair of side blocks pivotally coupled to the bracket and provided on either sides of the central block. Each side block includes a side tip holder detachably coupled to a lower portion of the side block and a side contact tip attached to the side tip holder. Each of the side contact tip is adapted to receive the electrode. The side blocks are capable of variable positioning relative to the bracket.

In another aspect of the present invention, a method is provided. The method provides a welding head having a bracket, a central block and a pair of side blocks coupled to the bracket. The method attaches, detachably, a tip holder having a plurality of contact tips to a lower portion of the central block and a side tip holder having a plurality of side contact tips to a lower portion of each of the pair of side blocks. The method then receives an electrode in each of the contact tips and the side contact tips. The method further adjusts the position of the side blocks relative to the bracket and deposits a cladding material on the workpiece.

Other features and aspects of this disclosure will be apparent from the following description and the accompanying drawings.

### BRIEF DESCRIPTION OF THE DRAWINGS

FIG. 1 is a schematic illustration of an exemplary cladding machine according to one embodiment of the present disclosure;

FIG. 2 is a front elevation view of an exemplary welding head according to one embodiment of the present disclosure;

FIG. 3 is a front elevation view of an exemplary welding head according to another embodiment of the present disclosure;

FIG. 4 is an exploded perspective view of an exemplary side block according to one embodiment of the present disclosure;

FIG. 5 is an exploded perspective view of an exemplary bracket according to one embodiment of the present disclosure;

FIG. 6 is a rear perspective view of an exemplary welding head and a supply of inert gas or compressed air according to one embodiment of the present disclosure; and

FIG. 7 is a flowchart of an exemplary method for depositing a cladding material on a workpiece.

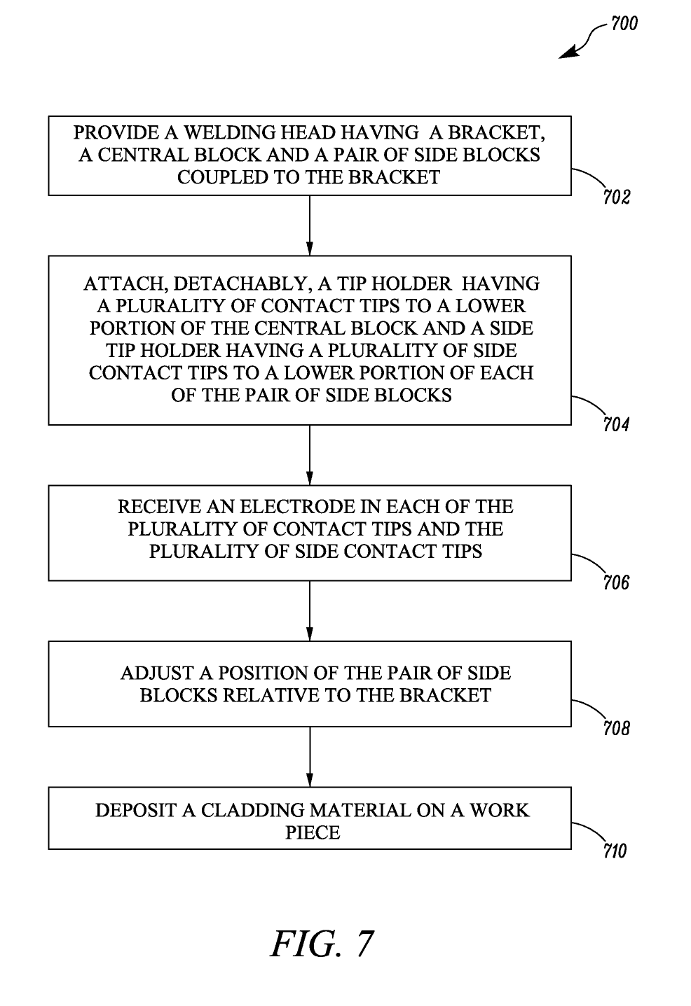

### DETAILED DESCRIPTION

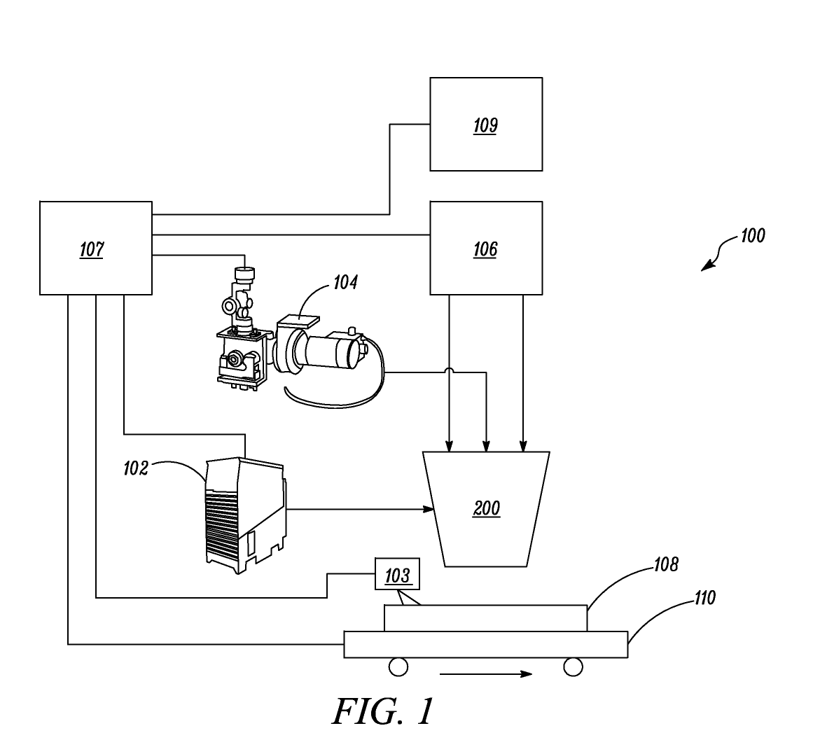

FIG. 1 illustrates an exemplary cladding machine 100 according to one embodiment of the present disclosure. The cladding machine 100 can include a power source 102, a laser tracking device 103, a group of wire feeders 104, a flux system 106, a controller 107, a multiple-axis motion system 109 and a travel carriage 110. In one embodiment, the cladding machine 100 can be used to deposit a cladding material on a workpiece 108 using submerged arc welding or any other known welding process.

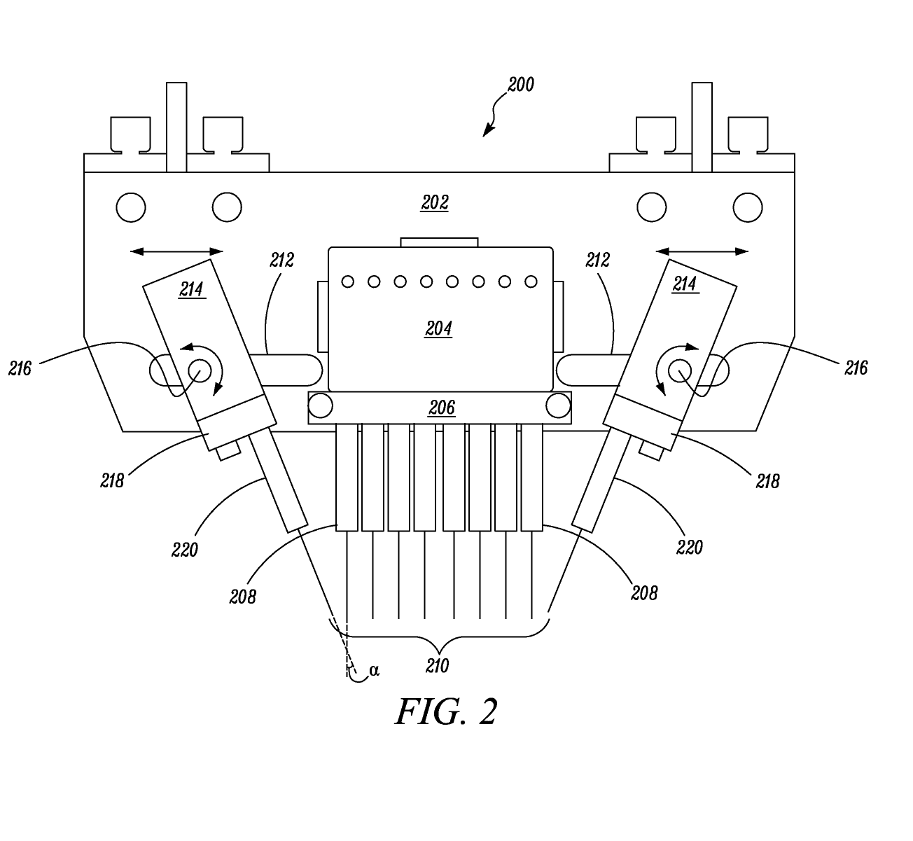

The cladding machine 100 can also include a welding head 200, and the power source 102 can be connected to welding head 200, as schematically illustrated in FIG. 1 and as further illustrated in any one or more exemplary embodiments shown in FIGS. 2-6 and discussed herein. In one embodiment more than one power source 102 may be used, and it will be appreciated that a plurality of electrodes may be powered by a single power source 102. The power source 102 can either be a DC or AC power source 102 such that a controlled voltage and welding current is maintained during a cladding process. The power source 102 in conjunction with the wire feeders 104 can be configured to supply filler material or electrodes to the welding head 200. In one embodiment, the electrodes can be fed into a single molten pool using a common potential.

In one embodiment, the flux system 106 provides a granular mineral material or flux for covering the workpiece 108 or tip of the electrode. It should be noted that the power source 102, the wire feeders 104 and the flux system 106 may either be regarded as part of or external to the cladding machine 100. The cladding machine 100 may include the travel carriage 110 on which the workpiece 108 is placed. The direction of movement of the travel carriage 110 is depicted by an arrow, as shown in the exemplary embodiment illustrated in FIG. 1. The movement of the travel carriage 110 may either be controlled manually or automatically.

Parameters such as travel speed and direction of the travel carriage 110 may vary. More specifically, the travel speed of the travel carriage 110 may determine thickness of a cladding layer formed on the workpiece 108. Alternatively, the workpiece 108 may be kept stationary, while the welding head 200 is moved over the workpiece 108. It will be appreciated that the setup described herein is merely on an exemplary basis and does not limit the scope of this disclosure. It may be understood that the cladding machine 100 may include additional components or sub-systems as known in the art.

The welding head 200 which may be attached to the cladding machine 100 by any suitable connecting method, such as by bolting, riveting, welding or any combination thereof. As illustrated in one exemplary embodiment shown in FIG. 2, the welding head 200 can include a bracket 202. The bracket 202 can have a plate like configuration defined by dimensional parameters like width, height and thickness. A central block 204 can be fixedly coupled to the bracket 202 at the lower central location of the bracket 202, wherein in one embodiment, the central block 204 is fixedly coupled to a front surface of the bracket 202. As shown in the exemplary embodiments illustrated in FIGS. 2 & 3, a tip holder 206 can be detachably attached or mounted to a lower portion of the central block 204. The tip holder 206 can be configured to hold one or more contact tips 208. Each contact tip 208 can receive an electrode 210 used for the cladding operation, consistent with the disclosure as provided above and as further provided herein. The electrode 210 may be gas-shielded, self-shielded, or metal cored. Moreover, the electrode 210 may be solid, metal core, or flux cored wires.

In one embodiment, the central block 204 can have a fixed configuration with respect to the bracket 202. Additionally, the shape of the central block 204 can be configured such that the contact tips 208 provided on the lower portion of the central block 204 are in a linear arrangement. The number of electrodes 210 attached to the central block 204 may vary. In the illustrated, exemplary embodiment, eight contact tips 208 are attached to the central block 204.

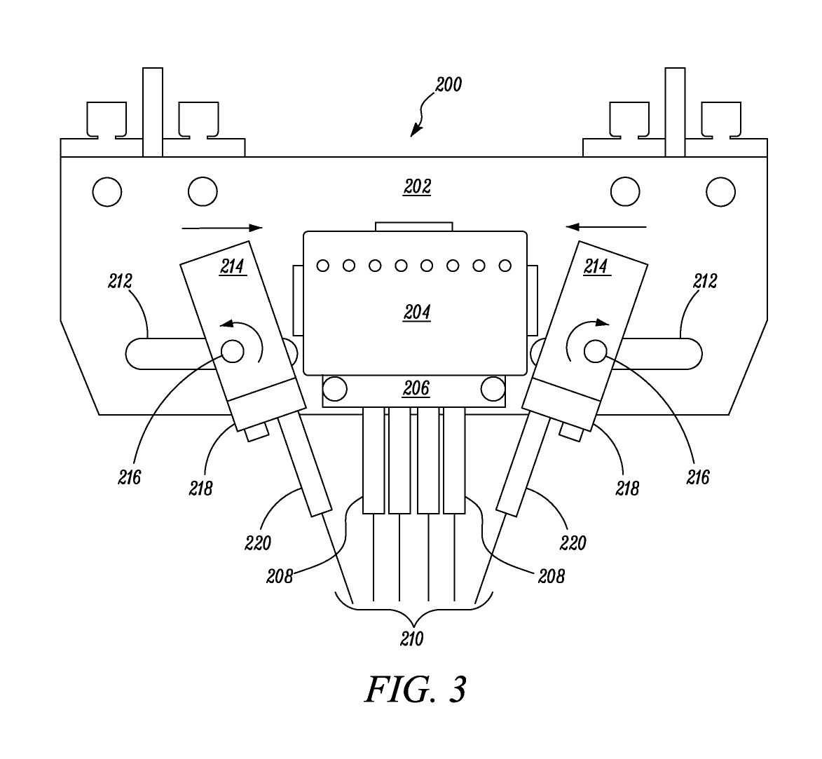

The bracket 202 can include at least one horizontal linear groove 212 disposed therein or therethrough such that each horizontal linear groove 212 is positioned on either side of the central block 204. In one embodiment, the bracket 202 includes a pair of horizontal linear grooves 212 positioned laterally on each side of the central block 204 such that a symmetrical arrangement is formed. One or more side blocks 214 can each be pivotally mounted to the bracket 202 about a pivotal connection 216. In the illustrated embodiment, the side blocks 214 are mounted within the grooves 212 by bolting, or using any other method known in the art. It should be noted that the mounting of the side blocks 214 is such that the side block 214 is capable of lateral movement within the groove 212 and angular movement about the pivotal connection 216, as shown by the arrowheads in FIG. 2. In one exemplary embodiment, which will be described in detail in connection with FIG. 3, the number of contact tips 208 associated with the central block 204 can be increased or decreased based on the movement of the side blocks 214.

Each side block 214 includes a side tip holder 218 detachably coupled to a lower portion of the respective side block 214. The side tip holders 218 carry a side contact tip 220 which is configured to receive the electrode 210 used for the cladding operation. It will be appreciated that although two separate rectilinear grooves 212 are shown in the illustrated embodiment, other arrangements to achieve the similar result may also be utilized. For example, a single continuous groove running from one side of the bracket 202 to the other side of the bracket 202 may be used. More particularly, the number and configuration of the grooves 212 may vary so as to achieve appropriate orientation of the side blocks 214 as per system design and/or operational requirements. The number of side contact tips 220 attached to the side blocks 214 may vary. In the illustrated exemplary embodiment, a single side contact tip 220 is provided on the lower portion of each of the side blocks 214.

Referring to the exemplary embodiment shown in FIG. 2, the side blocks 214 are oriented and positioned relative to the central block 204 in such a way so as to allow the side contact tip 220 adjacent to the contact tip 208 of the central block 204 to form an angle α with the respective contact tip 208. The arrangement of the side contact tips 214 on either side of the contact tips 208 associated with the central block 204 may form an arcuate shaped setup.

As illustrated by exemplary embodiment shown in FIG. 3, the welding head 200 can have comparatively lesser number of electrodes 210 as compared to the arrangement shown in FIG. 2. As described earlier, the number of contact tips 208, 220 associated with any of the central and/or side blocks 204, 214 may be increased or decreased. The setup shown in FIG. 3 has four contact tips 208 associated with the central block 204, as compared to eight contact tips 208 shown in the arrangement in FIG. 2.

It will be appreciated that the number of contact tips 208 associated with the design of the welding head 200 shown in the accompanying figures may include either eight, six or four contact tips 208. However, the design of the welding head 200 may be accordingly modified to include lesser or more number of contact tips 208 as the case may be. Accordingly, in order to accommodate the change in the number of contact tips 208, the side blocks 214 may be moved closer to the central block 204 along the grooves 212 in a horizontal direction as shown in the figure.

In one embodiment, the side blocks 214 may also be angularly adjusted with respect to the central block 204 about the pivotal connection 216 as per operational requirements. More particularly, the arrangement of the side contact tips 220 and the contact tips 208 on the central block 204 may be adjusted to form an arcuate shaped arrangement of the electrodes 210. It will be appreciated that the electrodes 210 may be arranged in different planes. It should be understood that the positioning of the side blocks 214 relative to the central block 204 and the angular orientation of the side blocks 214 may be adjusted manually. Alternatively, the side blocks 214 may also be adjusted automatically by a controller, such as controller 107. One of ordinary skill in the art will appreciate that the configuration of the welding head 200 shown herein is merely on an exemplary basis. Multiple configurations of the central block 204 and the side blocks 214, other than the ones explained herein, may be formed as per system needs.

The contact tips 208 associated with the central block 204 and/or the side contact tips 220 associated with the side block 214 may need to be changed or replaced during usage. Also, in some situations where the number of the contact tips 208 or side contact tips 220 needs to be changed, the respective contact tips 208 or side contact tips 220 may need to be removed from the welding head 200.

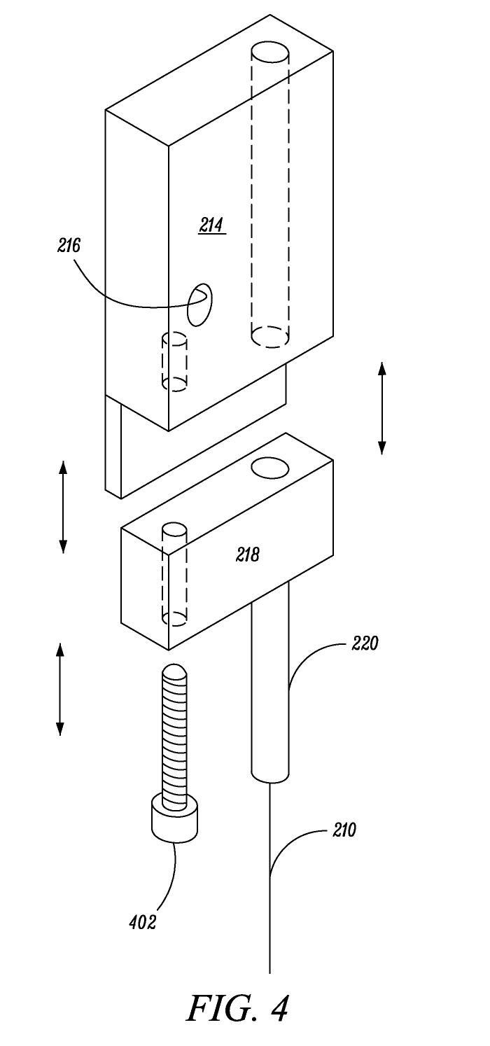

As illustrated by the exemplary embodiment shown in FIG. 4, the side tip holder 218 can be detachably coupled to the lower edge of the side block 214. The side tip holder 218 is provided with the side contact tip 220 adapted to receive the electrode 210. The detachable coupling of the side tip holder 218 with respect to the side block 214 may be provided in such a way so as to facilitate ease of removal and installation of the side contact tip 220 from/to the side block 214.

The detachable coupling may be provided in a number of ways. For example, as shown, a screw 402 can be used. Alternatively, bolting or similar methods known in the art may also be utilized. One of ordinary skill in the art will appreciate that when the side tip holder 218 is completely replaced with a ready set of the new side tip holder 218 and side contact tips 220, the overall productive time loss may be considerably reduced. It should be understood that in a similar manner, the tip holder 206 may be detachably coupled to the central block 204.

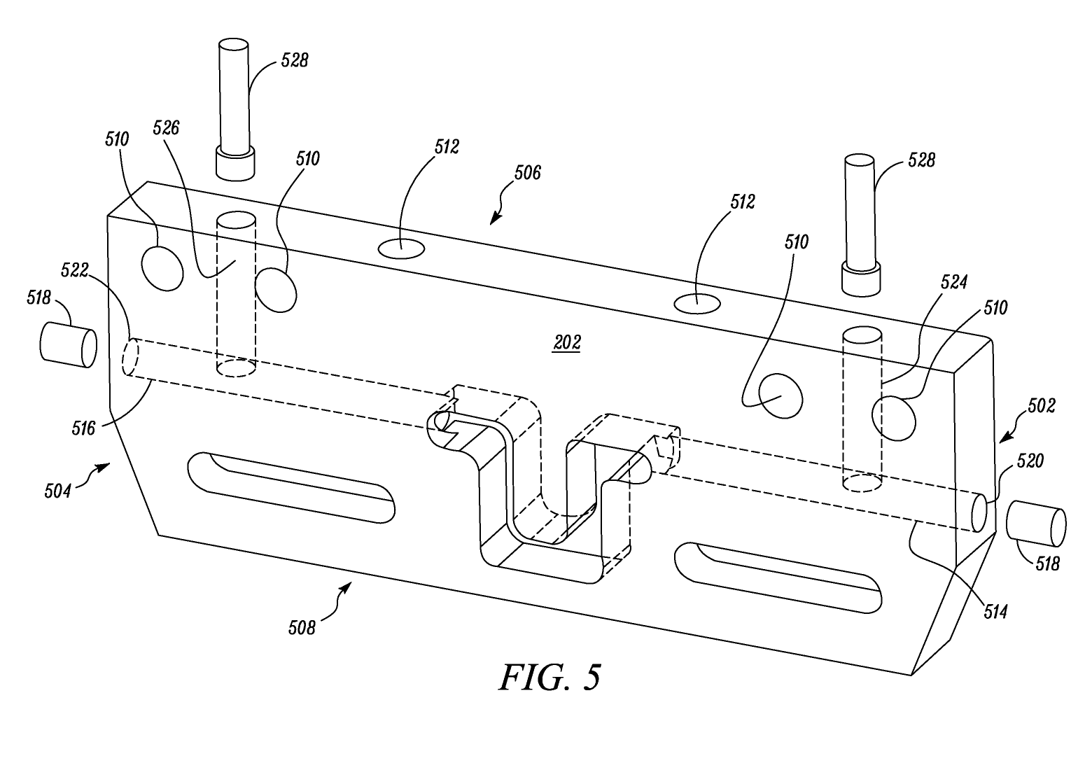

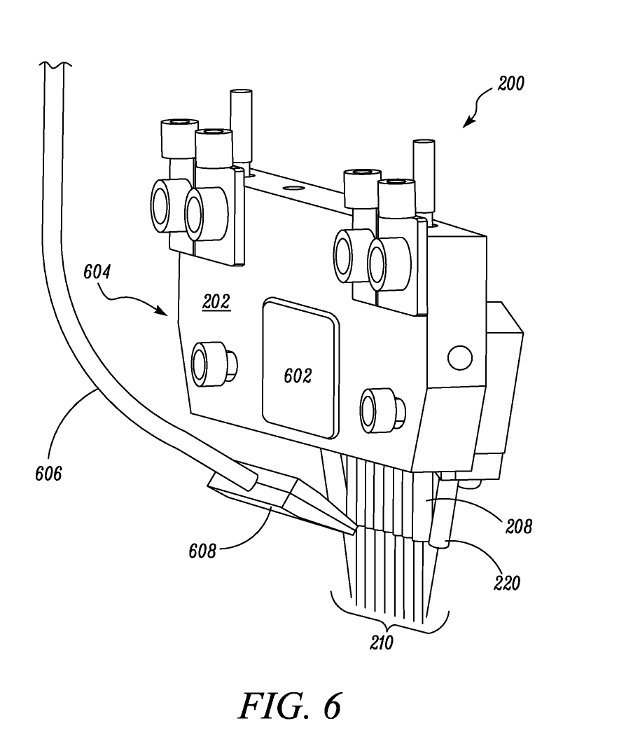

As illustrated by exemplary embodiment shown in FIG. 5, the bracket 202 includes a first end 502, a second end 504, a top end 506 and a bottom end 508. Holes 510 are provided proximate to the top end 506 of the bracket 202 for mounting of cable connectors (shown in FIG. 6) for connection to the power source 102. Holes 512 are provided proximate to the central portion of the top end 506 to mount the bracket 202 to an insulation member (no shown) that is then attached to the cladding machine.

In one embodiment, a plurality of channels 514, 516 is provided within the bracket 202. The channels 514, 516 are configured to provide a flow path for a coolant through the bracket 202, in order to prevent overheating of the bracket 202 during the cladding process. As shown in the accompanying figure, the channels 514, 516 may be drilled horizontally in the bracket 202, such that the channels 514, 516 run laterally from the first end 502 to the second end 504 of the bracket 202. The channels 514, 516 come in fluid communication with each other at the central portion of the bracket 202 forming a U-shaped configuration proximate to the central block 204 mounting position on the bracket 202 surface. The configuration of the channels 514, 516 described herein is merely exemplary.

Plugs 518 may be inserted in ports 520, 522 provided at the first end 502 and the second end 504 to fluidly seal and prevent leakage of the coolant from the channels 514, 516. The plugs 518 may prevent coolant leakage from the bracket 202. Additional channels 524 may be drilled vertically in the bracket 202 to bring the top end 506 of the bracket in fluid communication with the channels 514, 516. The coolant supply arrangement, for example a hose adapter 528, can be connected to the channels 524, 526 at the top end 506 of the bracket 202 in order to introduce and/or remove the coolant from the bracket 202. A cover plate 602 (as shown in the exemplary embodiment of FIG. 6) is attached to a rear end 604 of the bracket 202 to fluidly seal the channels 514, 516 at the central portion of the bracket 202. The coolant may be a water based coolant, oil based coolant or any other cooling fluid known in the art. One skilled in the art may appreciate that the design and configurations of the channels 514, 516, 524, 526 provided within the bracket 202 may vary without departing from the intended operational scope of the disclosure.

As illustrated by exemplary embodiment shown in FIG. 6, a tube 606 having a nozzle 608 attached to one end may be placed proximate to the rear end 604 of the welding head 200. A stream of inert gas and/or compressed air may be supplied through the tube 606 and directed through the nozzle 608 to the array of contact tips 208 and side contact tips 220. The supply of the inert gas or the compressed air may prevent spreading of the arc flame from one electrode 210 to another during the cladding process. The inert gas or compressed air may be supplied from an inert gas or pressurized air storage like gas cylinders (not shown). The gas cylinders may be a part of or may be external to the cladding machine. In one embodiment, the insulation member (not shown) may be mounted behind the welding head 200.

### INDUSTRIAL APPLICABILITY

Multiple electrode cladding is a high power process requiring high current requirements, high process temperatures and high abrasion rates of the working elements of the welding head. Due to high process temperatures, the contact tips attached to the welding head may have a tendency to get worn out relatively rapidly. The wearing out of the contact tips may further accelerated by abrasive wear caused by leaked high hardness metal powder from the cored electrode in wire feeding process. Hence, frequent replacement of the contact tips may be required. Due to space constraints between the contact tips, the known multiple electrode welding head designs may present ergonomic issues on the part of the operator to replace the contact tips which are positioned in relatively inaccessible locations on the welding head, thereby making the replacement operation time consuming.

Further, due to high electric current requirements of the cladding process, the welding head may heat up to unacceptable levels, mainly due to heat generated by electric resistance and heat from molten metal and slag. In one exemplary cladding process, the electric current units required may be as high as 2,000 Amperes and 30 to 34 Volts.

In addition to this, arc flame control may also pose to be an issue with the known welding head designs. The arc flame may tend to spread when cladding operation is carried out with specific electrodes. In one example, some electrodes may present difficulties in the arc flame control during the cladding process. The flame surrounding the contact tips and a bottom surface of the welding head may accelerate the wear out of the contact tips. Additionally, other components associated with the welding head such as the flux feeding nozzle and the insulator member may get damaged due to catching of fire.

The present disclosure provides the welding head 200 for multiple electrode cladding process having the variable electrode 210 positioning including lateral and angular movement, and quick changing contact tips 208 coupled to the tip holder 206. Moreover, in one embodiment a cooling arrangement in the form of the channels 514, 516, 524, 526 provided within the bracket 202 may prevent overheating of the welding head 200. The arc flame control may be provided by the supply of the inert gas or the compressed air.

At step 702, the welding head 200 is provided having the bracket 202, the central block 204 and the pair of side blocks 214 coupled to the bracket 202. The central block 204 is mounted fixedly at the lower central portion of the bracket 202. The side blocks 214 are adjustably mounted on the bracket 202 adjacent to the central block 204.

At step 704, the tip holder 206 having a plurality of contact tips 208 is detachably attached to the lower portion of the central block 204. Additionally, the side tip holders 214 having at least one side contact tip 220 each is detachably attached to the lower portion of each of the side blocks 214. The pair of side blocks 214 is mounted on either sides of the central block 204. In one embodiment, the side blocks 214 are positioned within the groove 212 and pivotally coupled to the bracket 202, to facilitate the lateral and/or angular movement of the side blocks 214. At step 706, the electrode 210 is received in each of the contact tips 208 and the side contact tips 220. The electrode 210 is fed by the wire feeder 104 which may be intrinsic or extrinsic to the cladding machine.

Thereafter, at step 708, the position of the pair of side blocks 214 relative to the bracket 202 may be adjusted. The position may need to be adjusted based on a variety of factors, for example, depending on the spread of cladding required per run on the workpiece 108. Depending on the width of spread of the cladding required per run, the side blocks 214 may be positioned farther or nearer to the central block 204 at the appropriate angle α relative to the contact tips 208 associated with the central block 204. The positioning of the side blocks 214 may also be required to be adjusted depending on the number of contact tips 208 associated with the central block 204. The number of contact tips 208 may vary as per the thickness and/or quality of the cladding required.

Further, the number of contact tips 208 may also vary depending on the electrode 210 and the workpiece 108 material. Lesser number of contact tips 208 associated with the central block 204 may require the side blocks 214 to be moved closer to the central block 204, while a greater number of contact tips 208 associated with the central block 204 may require the side blocks 214 to be moved further away from the central block 204. Thus, the side blocks 214 may be laterally moved towards or away from the central block 204 to form a symmetrical arrangement of the electrodes 210 having the desired spacing. Further, the side blocks 214 may be angularly moved about the pivotal connection 216 in order for the side contact tips 220 to form the angle α with the contact tips 208 coupled to the central block 204. The adjustment of the side blocks 214 may be done manually or automatically.

Subsequently, at step 710, the cladding material may be deposited on the workpiece 108. The cladding operation may be performed by passing electric current through the welding head 200 and supplying electrode 210 through the contact tips 208 and the side contact tips 220. The high resistance to electric current between the electrode 210 tip and the workpiece 108 may create high heat of resistance enough to create an electric arc, similar to conventional welding process. The arc temperature may be sufficient enough to melt the electrode 210 and form a coat on the workpiece 108, thus cladding the workpiece 108 with the required material. Alternatively, flux may also be provided to the arc by the flux system 106 to cover the electrode 210 tip or the workpiece 108 depending on the type of cladding operation being performed.

Additionally, the welding head 200 may also be cooled to prevent overheating by providing the coolant flow through the channels 514, 516, 524, 526 provided within the bracket 202. To prevent the welding arc from spreading, the supply of the inert gas or compressed air may be provided from behind the welding head 200. This feature may locally protect the welding arc by a cloud of gas or air, and thereby prevent the welding arc from burning out of control. This may further help to reduce the accelerated wear of the contact tips 208 and side contact tips 220, prevent damage to the flux feeding nozzle (not shown) and the insulation member (not shown) from the high heat of the uncontrolled welding arc.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A welding head comprising:
a bracket;
a central block coupled to the bracket, the central block comprising:
a tip holder detachably coupled to a lower portion of the central block; and
a plurality of contact tips attached to the tip holder,
wherein each of the plurality of contact tips is adapted to receive an electrode; and
a pair of side blocks pivotally coupled to the bracket, each of the pair side blocks provided on either side of the central block, the each of the pair of side blocks comprising:
a side tip holder detachably coupled to a lower portion of the pair of side blocks; and
a plurality of side contact tips attached to the side tip holder, wherein each of the plurality of side contact tips is adapted to receive the electrode;
wherein the pair of side blocks is capable of variable positioning relative to the bracket.

2. The welding head of claim 1, wherein the bracket further comprises a plurality of channels provided within the bracket, the plurality of channels configured to allow a coolant flow within the welding head.

3. The welding head of claim 1 further including a supply of at least one or an inert gas and compressed air provided to the plurality of contact tips and the plurality of side contact tips, the supply configured to prevent spreading of a flame associated with the electrode.

4. The welding head of claim 1, wherein the central block has a fixed position relative to the bracket.

5. The welding head of claim 1 further including at least one groove provided on the bracket, the pair of side blocks configured to be variably positioned along the at least one groove.

6. The welding head of claim 5, wherein the at least one groove has a linear configuration.

7. The welding head of claim 5, wherein the variable positioning of the pair of side blocks relative to the bracket further includes lateral movement of the pair of side blocks along the at least on groove.

8. The welding head of claim 1, wherein the variable positioning of the pair of side blocks relative to the bracket further includes angular movement of the pair of blocks about a pivotal connection provided on the bracket.

9. The welding head of claim 1, wherein an arrangement of the plurality of side contact tips associated with the pair of side blocks and the plurality of contact tips associated with the central block has an arcuate shape.

10. The welding head of claim 1 wherein the central block is configured to be expandable to increase or decrease a number of the contact tips associated with the central block based on the variable positioning of the pair of side blocks.

11. The welding head of claim 1, wherein the welding head is connected to a power source.

12. The welding head of claim 1 further including an insulation member mounted behind the welding head.

13. The welding head of claim 1, wherein the position of the pair of side blocks is adjusted manually or automatically.

14. A method comprising:
providing a welding head having a bracket, a central block and a pair of side blocks coupled to the bracket;
attaching, detachably, a tip holder having a plurality of contact tips to a lower portion of the central block and a side tip holder having a plurality of side contact tips to a lower portion of each of the pair of side blocks;
receiving an electrode in each of the plurality of contact tips and the plurality of side contact tips;
adjusting a positioning of the pair of side blocks relative to the bracket; and
depositing a cladding material on a workpiece.

15. The method of claim 15 further comprising providing a coolant flow within a plurality of channels located within the welding head.

16. The method of claim 14 further comprising providing a supply of at least one or an inert gas and compressed air to the plurality of contact tips and the plurality of side contact tips to prevent spreading of a flame associated with the electrode.

17. The method of claim 14, wherein adjusting a positioning of the pair of side blocks further comprises laterally moving the each of the pair of side blocks along at least one groove provided on the bracket.

18. The method of claim 14, wherein adjusting a positioning of the pair of side blocks further comprises angularly moving the each of the pair of side blocks about a pivotal connection provided on the bracket.

19. The method of claim 14 further including increasing or decreasing a number of the contact tips associated with the central block based on the variable positioning of the pair of side blocks.

20. A cladding machine comprising:
a power source;
a wire feeder;
a flux system;
a travel carriage; and
a welding head affixed to the cladding machine, the welding head comprising:
a bracket;
a central block coupled to the bracket, the central block comprising:
a tip holder detachably coupled to a lower portion of the central block; and
a plurality of contact tips attached to the tip holder,
wherein each of the plurality of contact tips is adapted to receive an electrode; and
a pair of side blocks pivotally coupled to the bracket, each of the pair side blocks provided on either side of the central block, the each of the pair of side blocks comprising:
a side tip holder detachably coupled to a lower portion of the pair of side blocks; and
a plurality of side contact tips attached to the side tip holder, wherein each of the plurality of side contact tips is adapted to receive the electrode;
wherein the pair of side blocks is capable of variable positioning relative to the bracket.
